(19) United States
(12) Patent Application Publication
(10) Pub. No.: US 2009/0122655 A1
(43) Pub. Date: May 14, 2009

(54) TOOTHED WHEEL, CORRESPONDING GEAR SYSTEM AND CLOCK MOVEMENT, FOR A TIMEPIECE

(76) Inventor: Jean-Pierre GOLAY, Sion (CH)

Correspondence Address: OSTROLENK FABER GERB & SOFFEN, 1180 AVENUE OF THE AMERICAS, NEW YORK, NY, 100368403, US

(21) Appl. No.: 12/270,046

(22) Filed: Nov. 13, 2008

(30) Foreign Application Priority Data
Nov. 14, 2007 (CH) 2007 1762/07

(51) Int. Cl. G04F 7/00

(52) U.S. Cl. 368/101

(57) ABSTRACT

The present disclosure describes a toothed wheel for a gear system of a clock movement, comprising a plate provided with a toothing on its periphery, said toothing comprising a plurality of teeth, each of which has a dedendum extending from said plate and in the continuation of which an addendum is formed. Each of the teeth of the wheel is designed in such a way that its dedendum has a width smaller than that of its addendum and, preferably, a length equal to or greater than that of the addendum. It is moreover provided that the addendum has a tip located on a radius (R) of the plate and from which there extend, on both sides of the radius, a first portion, which is substantially rectilinear, to a distance from said radius which is greater than half the width of the dedendum, then a second portion, which is concave, joining the first portion to the dedendum. It is thus possible to use a gear system comprising two wheels of this type arranged in engagement with one another, and also a mechanism which makes it possible to displace at least one of these wheels with respect to the other so as to modify the distance between the axes, without thereby compromising the engagement.

### TECHNICAL FIELD

The present invention relates to a toothed wheel for a gear system of a clock movement, comprising a plate provided with a toothing on its periphery, the toothing comprising a plurality of teeth, each of which has a dedendum extending from the plate and in the continuation of which an addendum is formed, the addendum having a width greater than that of the dedendum. The invention also relates to a gear system and to a clock movement which are provided with such a toothed wheel, and also to a timepiece, the movement of which is provided with such a toothed wheel.

### PRIOR ART

Toothed wheels are commonly used in clock movements, to perform various functions. In addition to its function, a large number of parameters relating to the use of a toothed wheel influence the shape of its teeth, in particular its location in the kinematic chain of the movement, the fact that it meshes permanently with another wheel or sequentially, the fact that there are certain amounts of meshing play that are to be limited or not, its dimensions relative to those of another wheel with which it is designed to mesh, etc.

The patent application FR 2 867 543 A1 has, in one of its embodiments, a particular type of toothed wheel which satisfies the definition given above. It is clear from this document that the profile of the tooth that is disclosed meets specific requirements, namely that of allowing the toothed wheel to mesh with cylinders carried at the periphery of an adjacent wheel and oriented along axes parallel to the axes of rotation of the wheels, so as to constitute a lantern gear.

To return to gear systems which make use of more conventional toothed wheels, FIG. 1 shows part of a clock movement having a chronograph function, based on a structure which is very widespread in the prior art. This movement comprises a coupling device which acts when starting and stopping the time measurement, said coupling device comprising a lever 100 mounted on the frame of the movement so as to be able to pivot between two positions about an axle 101, depending on the angular position of a column wheel 102, so as to establish or interrupt a kinematic link between the going train of the movement and a chronograph train.

A seconds wheel 103 is constantly driven by the going train of the movement and is arranged in engagement with a wheel which performs the function of a coupling device setting wheel 104.

In a first position of the lever, namely that shown in FIG. 1, the chronograph function is stopped and the setting wheel 104 rotates idly while the lever bears against a column of the column wheel. When the column wheel rotates by one pitch, the lever falls between two columns by rotating in the clockwise direction in FIG. 1. The setting wheel 104 then enters into engagement with a wheel of the chronograph train, typically the chronograph wheel 105, which is designed to drive a member for displaying the seconds of the measured time.

In general, the teeth of the setting wheel 104 and of the chronograph wheel 105 have a triangular profile, as can be seen in FIG. 1, which makes it possible to facilitate the meshing thereof during the movement of the coupling device lever when the chronograph is triggered.

However, timepieces comprising a clock movement of the type that has just been described have a drawback which arises when time measurements are activated, in that the rotational movement of the lever 100 about the axle 101 when the chronograph is triggered, more particularly that of the coupling device setting wheel 104, causes a parasitic movement of the chronograph wheel 105 when the coupling device setting wheel enters into contact with it. The parasitic movement of the chronograph wheel causes a parasitic movement of the seconds display member which the person wearing the watch can detect, which is not very favourable for the manufacturer's image in terms of quality, particularly with regard to a top-of-the-range timepiece.

The above movement is described in particular in the book entitled “Theorie d'horlogerie”, by C.-A. Reymondin et al., published by the Federation des Ecoles Techniques (Switzerland), ISBN 2-940025-10-X, on pages 234 and 235, where the stated problem is also mentioned.

Solutions have been proposed for solving the abovementioned problem, such as, for example, using a vertical or axial coupling device mechanism. In this type of mechanism, a coupling device setting wheel is displaced along its axis of rotation, which coincides with that of the chronograph wheel, when the chronograph is triggered. As a result, the chronograph wheel does not undergo the parasitic movement mentioned above.

However, these mechanisms are not only complex but are also bulky in the direction of the thickness of the movement. Therefore, it is not always possible to use these mechanisms, particularly if the movement comprises additional complications.

Another solution, which is proposed in the application EP 1 437 633 A1, consists in using a very particular profile of the toothing of the coupling device setting wheel which makes it possible to improve the quality of the contact between its toothing and the toothing of the chronograph wheel, but without completely solving the problem mentioned above.

### DISCLOSURE OF THE INVENTION

One object of the present invention is to overcome the aforementioned disadvantages of the prior art, by proposing a toothed wheel of alternative shape which is able to cooperate with another, similar toothed wheel in a plurality of relative positions associated with different values of the distance between the axes of the two wheels.

To this end, the toothed wheel according to the invention is characterised in that the dedendum of each tooth is substantially straight, and in that the addendum has a tip located on a radius of the plate or disc and from which there extend, on both sides of the radius, a first portion, which is substantially rectilinear, to a distance from the radius which is greater than half the width of the dedendum, then a second portion, which is concave, joining the first portion to the dedendum. Preferably, the dedendum has a length equal to or greater than that of the addendum.

By virtue of these features, it is possible to use a gear system comprising two wheels of this type arranged in engagement with one another, and also a mechanism which makes it possible to displace at least one of these wheels with respect to the other between at least one first operating position, in which the addenda of the teeth of one wheel cooperate with the side walls of the dedenda of the teeth of the other wheel, and one second operating position, in which the addenda of the teeth of one wheel cooperate with the addenda of the teeth of the other wheel.

Such a gear system can be used advantageously for example in a clock movement having a chronograph function, in order to remedy the problems mentioned above. It is thus possible, by virtue of the particular features of the toothed wheel according to the invention, to provide a coupling device comprising a coupling device setting wheel which moves between two positions associated with the on and off states of the chronograph function, in a direction substantially collinear to the line which joins the axis of a seconds wheel, namely a wheel driven by the going train and with which the coupling device setting wheel is in engagement, and the axis of a wheel of the chronograph train which is designed to be driven via the coupling device setting wheel.

In its displacement, the coupling device setting wheel moves away from and towards the seconds wheel while remaining in engagement with the latter when these two wheels have a structure according to the present invention.

The invention also relates to a timepiece comprising a movement according to the features disclosed above.

### BRIEF DESCRIPTION OF THE DRAWINGS

Other features and advantages of the present invention will become more clearly apparent on reading the following detailed description of one preferred embodiment which is given with reference to the appended drawings which are given purely by way of non-limiting examples and in which:

FIG. 1 shows a simplified plan view, from the bridge side, of part of a movement for a timepiece of the prior art;

FIG. 2 shows a simplified plan view, from the dial side, of part of a movement according to the present invention, in a first configuration;

FIG. 3 shows a simplified plan view similar to the view in FIG. 2, the movement being visible in a second configuration;

FIG. 4a shows a simplified plan view of a design detail of the movement of FIGS. 2 and 3, in the first configuration of FIG. 2;

FIG. 4b shows an enlarged detail of FIG. 4a; and

FIG. 5 shows a simplified plan view of a design detail of the movement of FIGS. 2 and 3, in the second configuration of FIG. 3.

### EMBODIMENT(S) OF THE INVENTION

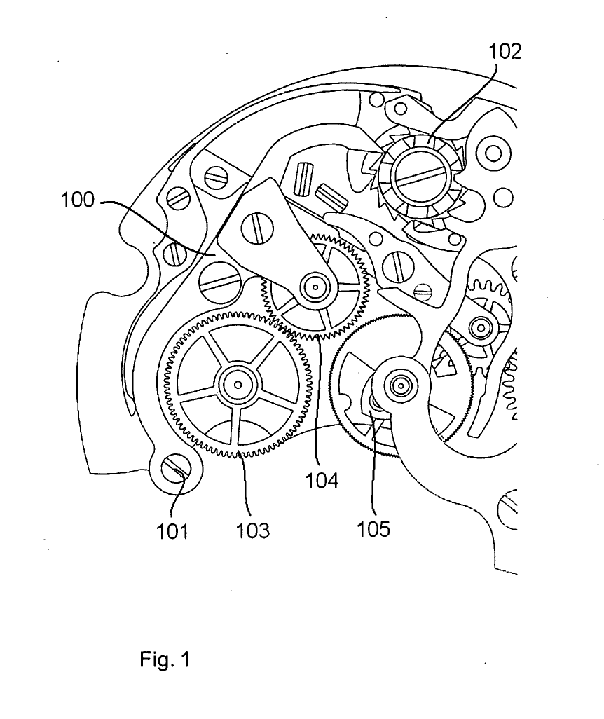

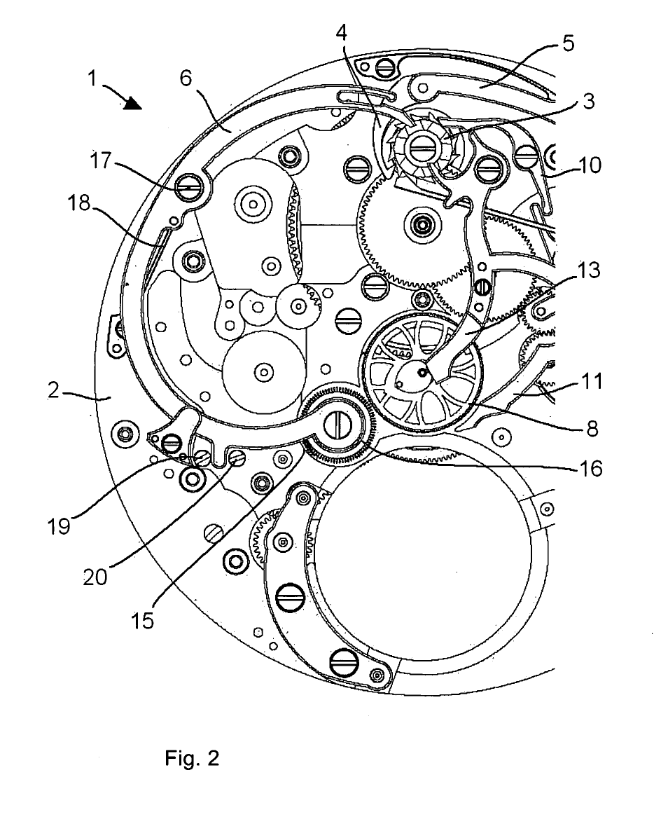

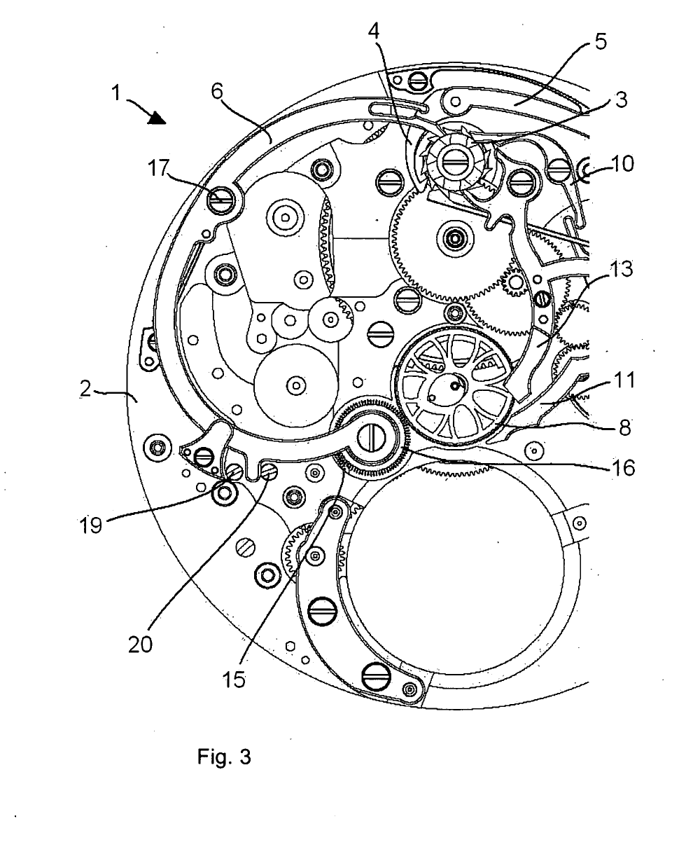

While FIG. 1 shows a simplified plan view, from the bridge side, of part of a movement for a timepiece known from the prior art having a chronograph function, FIGS. 2 and 3 show simplified plan views, from the dial side, of part of a movement 1 having a chronograph function according to the present invention, respectively in a first and in a second configuration.

It is obvious that this movement is shown by way of non-limiting example and that the person skilled in the art will be able to implement the subject matter of the present invention by adapting it to a chronograph mechanism arranged on the bridge side, like that in FIG. 1, without departing from the scope of the invention.

This movement 1 comprises frame elements including in particular a plate 2 on which there are mounted moving parts, levers and other conventional clockmaking components which will not be described in detail in the present text since most of said components are only distantly related to the present invention.

The clock movement is of the type having a chronograph with a column wheel 3. The latter can be driven in rotation by a hook 4, integral with a control member 5, the displacements of which can be controlled in a conventional manner on the basis of a push-button (not shown).

Each pressing of the push-button causes the column wheel 3 to rotate by one pitch, thereby making the chronograph function pass from an active state to a stopped state and vice versa. For this purpose, the alternating arrangement of peaks (the columns) and troughs acts on different levers 6, 7 which can be moved between two positions so as to make it possible to drive a chronograph train, including in particular the chronograph wheel 8, driven by a going train (not shown). The column wheel 3 also cooperates with a lever 10 acting on a brake-lever 11, the function of which, in a conventional manner, is to maintain the angular position of the chronograph wheel 8 when the measurement of a time is interrupted, and also with resetting hammer ends 12 and 13 which are triggered by another means. Typically, the column wheel makes it possible to lock the activation of the resetting hammers when the measurement of a time is in progress.

FIG. 2 shows the movement when the chronograph function is stopped, while the resetting hammers 12 and 13 are lowered so as to position the members for displaying the measured time at zero, whereas FIG. 3 shows this same movement while the measurement of a time is in progress.

The part of this movement which is of most particular interest in the context of the present description is that which drives the chronograph train, more specifically the chronograph wheel 8, based on the going train motion.

To this end, the movement comprises a seconds wheel 15 which is mounted in a rotational manner on the plate 2 by preferably being integral with the fourth wheel and pinion set (not visible) of the going train of the movement.

The seconds wheel 15 is arranged permanently in engagement with a wheel 16 carried by the coupling device lever 6 and playing the role of a coupling device setting wheel. The coupling device lever 6 is mounted in a pivoting manner on the plate 2, by means of a shouldered screw 17, being held in a first, released position corresponding to the position shown in FIG. 2 by the action of a coupling device spring 18. The released position is set and adjusted by means of a first eccentric 19 defining a first stop for the coupling device lever.

Since the seconds wheel 15 is permanently driven by the going train, the same is true of the coupling device setting wheel 16, which rotates idly in the released position of the coupling device lever.

A pressure exerted by a user on the push-button of the corresponding timepiece causes the column wheel 3 to rotate by one pitch (in the clockwise direction in the figures), which then raises the coupling device lever 6 so as to move it into a second, engaged position, as shown in FIG. 3.

The coupling device lever rotates in the anticlockwise direction so as to bring the coupling device setting wheel 16 into engagement with the chronograph wheel 8. The penetration of the toothing of the coupling device setting wheel into the toothing of the chronograph wheel can be adjusted by means of a second eccentric 20 mounted on the plate.

It can be seen from FIGS. 2 and 3 that the particular curved shape of the coupling device lever 6 makes it possible to transform its own rotational movement into a movement of its setting wheel approaching a rectilinear translation. This is because, between its first released position and its second engaged position, the coupling device setting wheel 16 has a displacement that is substantially collinear to the straight line joining the axes of rotation of the seconds wheel 15 and the chronograph wheel 8.

Thus, contrary to the mechanisms of the prior art, the coupling device setting wheel does not rotate around the seconds wheel in order to pass from the released position to the engaged position, and vice versa, but rather moves away from and towards said seconds wheel.

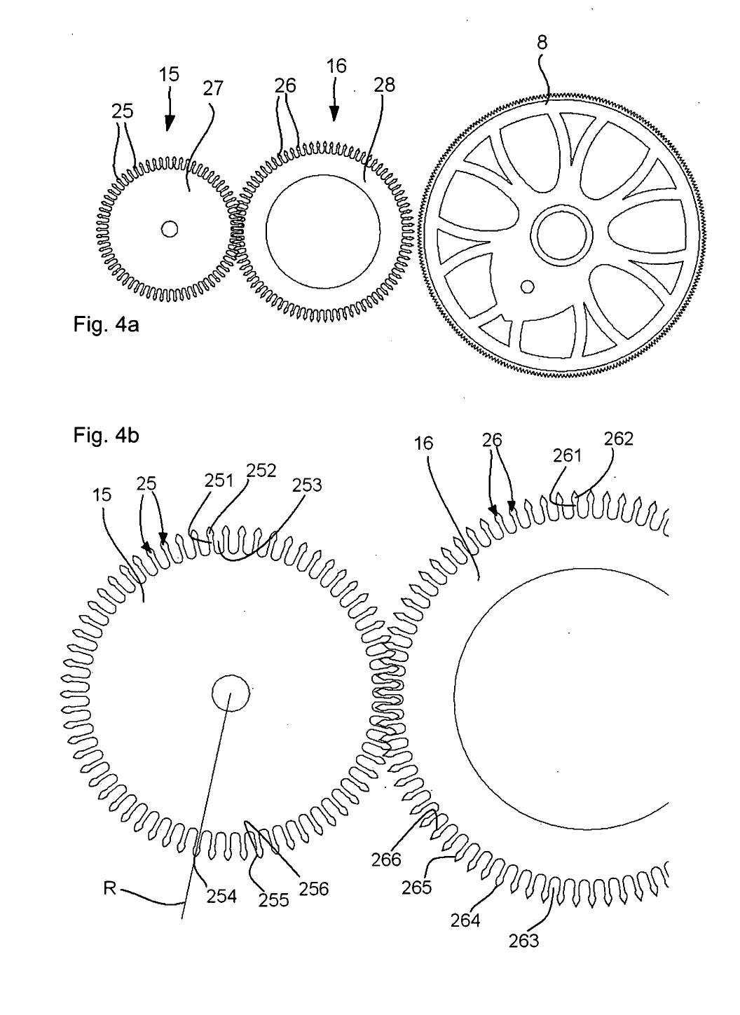

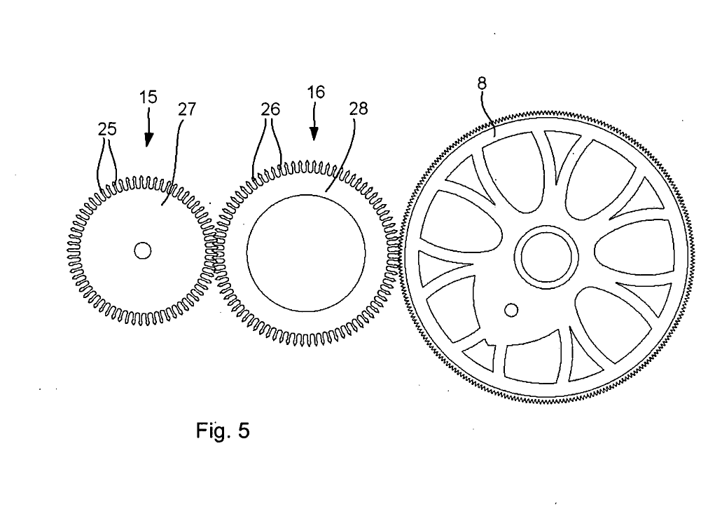

Such a relative movement between these two wheels is made possible by the use of a particular toothing, according to the present invention, as can be seen more clearly in FIGS. 4 and 5 which show a design detail of FIGS. 2 and 3.

FIGS. 4a and 5 show the relative positions between the seconds wheel 15, the coupling device setting wheel 16 and the chronograph wheel 8, respectively, in the released position and in the engaged position. The particular arrangement of these wheels will be noted, the respective axes of rotation of which are arranged so as to be substantially aligned, the coupling device setting wheel being located between the two wheels that are to be kinematically connected.

FIG. 4b shows an enlarged view of the structure of the teeth on which some details that will be described below are more visible.

The chronograph wheel 8 comprises a toothing, the teeth of which have a conventional triangular profile.

The seconds wheel 15 and the coupling device setting wheel 16 comprise toothings, the teeth 25, 26 of which have the same particular profile, these toothings being arranged on the periphery of the corresponding wheel disc 27, 28.

Each of the teeth 25 and 26 comprises a dedendum 251, 261, the width of which is smaller than the maximum width of the corresponding addendum 252, 262, the length of the dedendum moreover being substantially greater than that of the addendum. As a result, and because the space between two adjacent addenda of a wheel is necessarily greater than the width of one addendum of the other wheel so as to limit the friction during operation of the gear system, the tooth-space, that is to say the space 253, 263 located between two adjacent dedenda of a wheel, has dimensions which are generally greater than the dimensions of an addendum of the other wheel.

Preferably, the space 253, 263 located between two adjacent dedenda of a wheel has a width that is substantially constant from the addendum 252, 262 to the bottom of the toothing.

In the embodiment shown in the figures, by way of non-limiting example, the dedendum 251, 261 of each tooth 25, 26 has a substantially elongate, rectangular shape. The addendum 252, 262, which is symmetrical with respect to a radius R of the corresponding wheel, has, from its free end, a tip 254, 264 located on the aforementioned radius and from which a first portion 255, 265, which is substantially rectilinear, extends in the direction of the corresponding disc, to a distance from said radius which is greater than half the width of the corresponding dedendum. Each addendum 252, 262 comprises a second portion 256, 266 which is curved inwards and provides the join between the first portion 255, 265 and the dedendum 251, 261.

It will be noted that, because of this, each addendum 252, 262 has a profile similar to that of a conventional triangular tooth in its region located between its tip 254, 264 and its second portion 256, 266. In the embodiment described here by way of example, this latter feature makes it possible to ensure good meshing between the coupling device setting wheel 16 and the chronograph wheel 8.

Furthermore, the particular shape of the toothing which has just been described makes it possible for the wheels 15 and 16 to mesh with one another for different values of the corresponding distance between the axes, as can be seen from a comparison between the configurations of FIGS. 4a and 5.

FIG. 4a shows the relative position of these two wheels in the released position of the coupling device lever 6, corresponding to the view of FIG. 2. In this configuration, the two wheels 15 and 16 are brought together, the wheel 16 being out of range of the chronograph wheel 8.

In this case, a tooth of one of the two wheels 15, 16 which cooperates with the toothing of the other wheel penetrates almost fully into the space 253, 263 located between two teeth. The meshing then takes place by the interaction of the addendum of this tooth with the side wall (the downstream side wall with reference to the direction of rotation of the toothings) of a dedendum of the other toothing.

When the chronograph function is triggered, the coupling device setting wheel 16 following the movement of the coupling device lever 6 moves away from the seconds wheel 15 and is positioned in engagement with the chronograph wheel 8, as shown in FIG. 5.

The meshing between the coupling device setting wheel 16 and the chronograph wheel 8 is achieved via the addenda 262, which have a profile similar to that of the teeth of the prior art, the number of teeth of the chronograph wheel being greater than that of the coupling device setting wheel, in a conventional manner.

It can also be seen that the meshing between the seconds wheel 15 and the coupling device setting wheel 16 has been maintained during the displacement of the latter which has led to an increase in the distance between the axes of these two wheels. However, it appears that the consequence of this change in the distance between the axes is that the parts of the teeth which interact are modified. This is because the penetration of the two toothings has been reduced, so that the interaction between the two wheels takes place via the addenda 252, 262 of the teeth 25, 26. In this configuration, the meshing between the seconds wheel and the coupling device setting wheel is similar to a meshing that takes place between two conventional triangular toothings.

The above description attempts to describe one particular embodiment by way of non-limiting example, and the invention is not limited for example to the use of the wheels according to the invention for forming a chronograph coupling device. Likewise, the person skilled in the art will not encounter any particular difficulty in using a toothed wheel in which the tooth addendum has a profile other than triangular, depending on his specific requirements.

It may also be provided, alternatively and without departing from the scope of the present invention, that the toothing is a contrate toothing. In this case, two wheels according to the invention could be arranged in engagement by being coaxial with a variable distance between them.

1. Toothed wheel for a gear system of a clock movement, comprising a plate provided with a toothing on its periphery, said toothing comprising a plurality of teeth, each of which has a dedendum extending from said plate and in the continuation of which an addendum is formed, said addendum having a width greater than that of said dedendum, wherein said dedendum is substantially straight, and
in that said addendum has a tip located on a radius (R) of said plate and from which there extend, on both sides of said radius,
a first portion, which is substantially rectilinear, to a distance from said radius which is greater than half the width of said dedendum,
then a second portion, which is concave, joining said first portion to said dedendum.

2. Toothed wheel according to claim 1, wherein said dedendum has a length equal to or greater than that of said addendum.

3. Toothed wheel according to claim 1, wherein said addendum is substantially symmetrical with respect to said radius (R) of said plate.

4. Toothed wheel according to claim 1, wherein two adjacent dedenda have between them a space of substantially constant width from said addendum to the bottom of the toothing.

5. Gear system for a clock movement, comprising at least one first and one second wheel according to claim 1 arranged in engagement with one another,
wherein it comprises a mechanism for displacing at least one of said wheels with respect to the other between at least
one first operating position, in which the addenda of the teeth of one wheel cooperate with the side walls of the dedenda of the teeth of the other wheel, and
one second operating position, in which the addenda of the first and second wheels cooperate with one another.

6. Clock movement having a chronograph function, comprising a coupling device designed to kinematically connect a first wheel according to claim 1, driven by a going train of the movement, to a wheel of a chronograph train,
wherein said coupling device comprises a second wheel according to claim 1, arranged on a movable support so as to be able to be displaced between at least one first operating position, in which it is not in engagement with said first wheel, and
one second operating position, in which it is simultaneously in engagement with said first wheel and with said wheel of the chronograph train.

7. Movement according to claim 6, wherein said movable support is a coupling device lever shaped in such a way that the displacement of said second wheel between its two operating positions is carried out in a direction substantially collinear to a straight line passing through the axes of said first wheel and wheel of the chronograph train.

8. Movement according to claim 7, wherein it comprises a column wheel arranged so as to cooperate with said coupling device lever in order to define two distinct positions thereof which are respectively associated with the operating positions of said second wheel.

9. Movement according to claim 6, wherein said first wheel, said second wheel and said wheel of the chronograph train have respective axes of rotation which are arranged so as to be substantially aligned.

10. Timepiece comprising a clock movement having a chronograph function according to claim 6, said casing being equipped with a push-button arranged so as to cause the displacement of said second wheel from one operating position to the other in response to a pressure exerted by a user.
